(19) United States
(12) Patent Application Publication
(10) Pub. No.: US 2025/0200918 A1
(43) Pub. Date: Jun. 19, 2025

(54) PROXIMITY TRIGGER IN SCENE DESCRIPTION

(71) Applicant: InterDigital CE Patent Holdings, SAS, Paris (FR)

(72) Inventors: Pierrick JOUET, Cesson-Sevigne (FR); Patrice HIRTZLIN, Cesson-Sevigne (FR); Loic FONTAINE, Cesson-Sevigne (FR); Sylvain LELIEVRE, Cesson-Sevigne (FR); Etienne FAIVRE D'ARCIER, Cesson-Sevigne (FR)

(21) Appl. No.: 18/848,459

(22) PCT Filed: Mar. 2, 2023
(86) PCT No.: PCT/EP2023/055275

§ 371 Date: Sep. 18, 2024

(30) Foreign Application Priority Data
Mar. 24, 2022 (EP) 22305362.0

(51) Int. Cl. G06T 19/20; G06F 3/16; G06T 15/40

(52) U.S. Cl. CPC G06T 19/20; G06F 3/165; G06T 15/40; G06T 2210/36; G06T 2210/61; G06T 2219/2004; G06T 2219/2016

(57) ABSTRACT

In one implementation, we propose to augment scene description by specifying the criteria of proximity at the node level for proximity triggering. For example, the scene description augmentation at the node level includes one or more of: (1) two weight parameters indicating the proximity importance to the node, (2) a reference to a simplified mesh attached to the node mesh, for the proximity computation and/or a proximity frustrum that defines a capture volume, (3) a Boolean parameter indicating whether occlusion is considered or not, (4) a Boolean parameter indicating if geospatial coordinates are used, and (5) the geospatial coordinates.

### TECHNICAL FIELD

The present embodiments generally relate to extended reality scene description and extended reality scene rendering.

### BACKGROUND

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way that is consistent with the user context (environment, point of view, device, etc.). Scene graphs (such as the one proposed by Khronos/glTF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Scene description frameworks ensure that the timed media and the corresponding relevant virtual content are available at any time during the rendering of the application. Scene descriptions can also carry data at scene level describing how a user can interact with the scene objects at runtime for immersive XR experiences.

### SUMMARY

According to an embodiment, a method is provided, comprising: obtaining at least a parameter, at node level, used to indicate that an object corresponding to a node is in proximity of another object corresponding to another node, from a description for an extended reality scene; and activating a trigger to an action responsive to that said object is in proximity of said another object.

According to another embodiment, an apparatus is provided, comprising one or more processors and at least one memory coupled to said one or more processors, wherein said one or more processors are configured to: obtain at least a parameter, at node level, used to indicate that an object corresponding to a node is in proximity of another object corresponding to another node, from a description for an extended reality scene; and activate a trigger to an action responsive to that said object is in proximity of said another object.

One or more embodiments also provide a computer program comprising instructions which when executed by one or more processors cause the one or more processors to perform the method according to any of the embodiments described herein. One or more of the present embodiments also provide a computer readable storage medium having stored thereon instructions for processing scene description according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 shows an example architecture of an XR processing engine.

FIG. 2 shows an example of the syntax of a data stream encoding an extended reality scene description.

FIG. 3 shows an example graph of an extended reality scene description.

FIG. 4 shows an example of an extended reality scene description comprising behavior data, stored at scene level, describing how a user can interact with the scene objects, described at node level, at runtime for immersive XR experiences.

FIG. 5 illustrates a proximity trigger at scene level.

FIG. 6 illustrates occlusion.

FIG. 7 illustrates a proximity frustum.

FIG. 8 illustrates a proximity trigger with frustum (not triggered).

FIG. 9 illustrates another proximity trigger with frustum (not triggered).

FIG. 10 illustrates a proximity trigger with frustum (triggered).

FIG. 11 illustrates a proximity trigger with a specific mesh.

FIG. 12 illustrates that the thresholds min and max are scaled.

FIG. 13 illustrates a method of parsing the glTF file and processing at runtime, according to an embodiment.

FIG. 14 illustrates a method of processing the glTF file at runtime with occlusion, according to an embodiment.

### DETAILED DESCRIPTION

Various XR applications may apply to different context and real or virtual environments. For example, in an industrial XR application, a virtual 3D content item (e.g., a piece A of an engine) is displayed when a reference object (piece B of an engine) is detected in the real environment by a camera rigged on a head mounted display device. The 3D content item is positioned in the real-world with a position and a scale defined relatively to the detected reference object.

For example, in an XR application for interior design, a 3D model of a furniture is displayed when a given image from the catalog is detected in the input camera view. The 3D content is positioned in the real-world with a position and scale defined relatively to the detected reference image. In another application, some audio file might start playing when the user enters an area close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, bird characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger. Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree comprises only virtual objects descriptions.

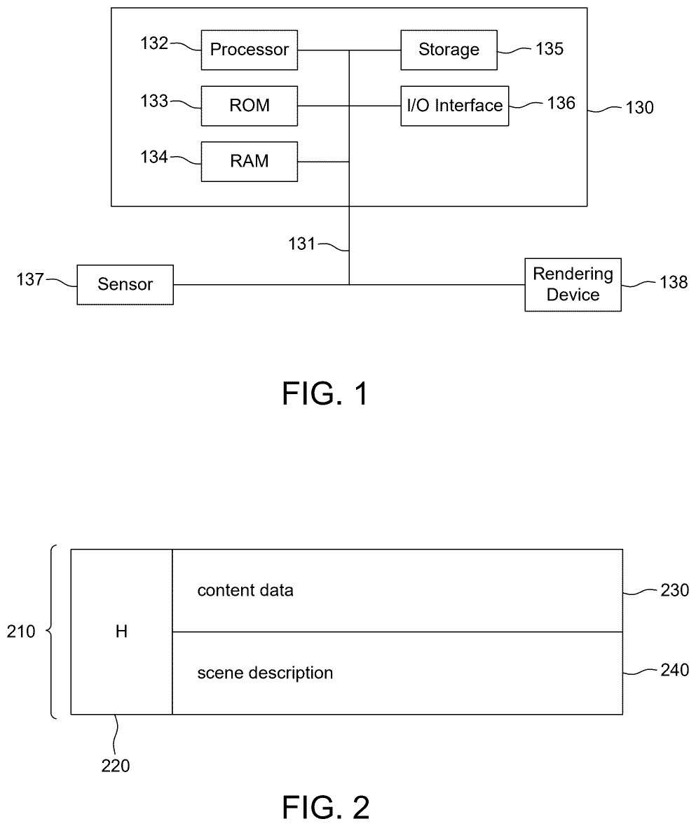

FIG. 1 shows an example architecture of an XR processing engine 130 which may be configured to implement the methods described herein. A device according to the architecture of FIG. 1 is linked with other devices via their bus 131 and/or via I/O interface 136.

Device 130 comprises following elements that are linked together by a data and address bus 131:
a microprocessor 132 (or CPU), which is, for example, a DSP (or Digital Signal Processor);
a ROM (or Read Only Memory) 133;
a RAM (or Random Access Memory) 134;
a storage interface 135;
an I/O interface 136 for reception of data to transmit, from an application; and
a power supply (not represented in FIG. 1), e.g., a battery.

In accordance with an example, the power supply is external to the device. In each of mentioned memory, the word “register” used in the specification may correspond to area of small capacity (some bits) or to very large area (e.g., a whole program or large amount of received or decoded data). The ROM 133 comprises at least a program and parameters. The ROM 133 may store algorithms and instructions to perform techniques in accordance with present principles. When switched on, the CPU 132 uploads the program in the RAM and executes the corresponding instructions.

The RAM 134 comprises, in a register, the program executed by the CPU 132 and uploaded after switch-on of the device 130, input data in a register, intermediate data in different states of the method in a register, and other variables used for the execution of the method in a register.

Device 130 is linked, for example via bus 131 to a set of sensors 137 and to a set of rendering devices 138. Sensors 137 may be, for example, cameras, microphones, temperature sensors, Inertial Measurement Units, GPS, hygrometry sensors, IR or UV light sensors or wind sensors. Rendering devices 138 may be, for example, displays, speakers, vibrators, heat, fan, etc.

In accordance with examples, the device 130 is configured to implement a method according to the present principles, and belongs to a set comprising:
a mobile device;
a communication device;
a game device;
a tablet (or tablet computer);
a laptop;
a still picture camera;
a video camera.

In XR applications, scene description is used to combine explicit and easy-to-parse description of a scene structure and some binary representations of media content. FIG. 2 shows an example of the syntax of a data stream encoding an extended reality scene description. FIG. 2 shows an example structure 210 of an XR scene description. The structure consists in a container which organizes the stream in independent elements of syntax. The structure may comprise a header part 220 which is a set of data common to every syntax element of the stream. For example, the header part comprises some of metadata about syntax elements, describing the nature and the role of each of them. The structure also comprises a payload comprising an element of syntax 230 and an element of syntax 240. Syntax element 230 comprises data representative of the media content items describes in the nodes of the scene graph related to virtual elements. Images, meshes and other raw data may have been compressed according to a compression method. Element of syntax 240 is a part of the payload of the data stream and comprises data encoding the scene description as described according to the present principles.

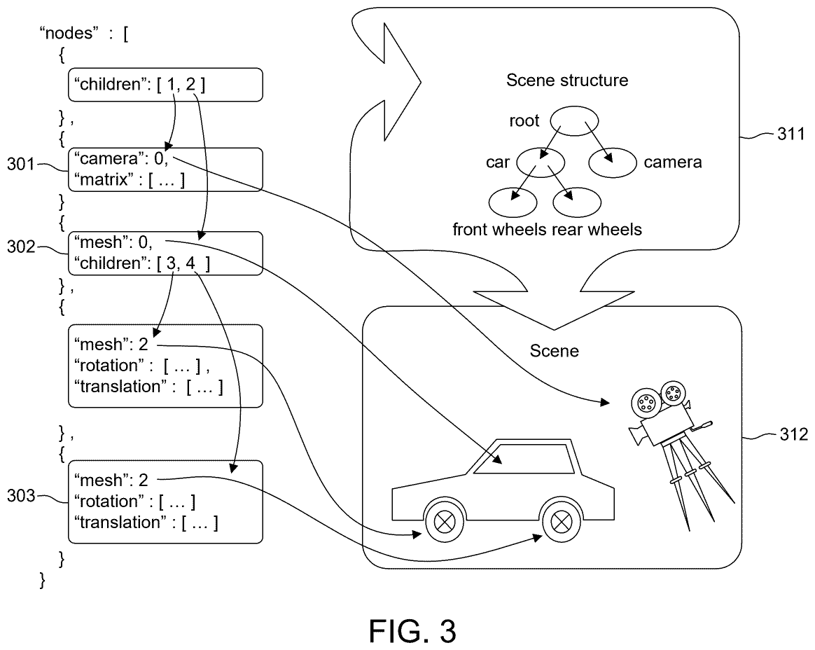

FIG. 3 shows an example graph 310 of an extended reality scene description. In this example, the scene graph may comprise a description of real objects, for example ‘plane horizontal surface’ (that can be a table or a road) and a description of virtual objects 312, for example an animation of a car. Scene description is organized as an array 310 of nodes. A node can be linked to child nodes to form a scene structure 311. A node can carry a description of a real object (e.g., a semantic description) or a description of a virtual object. In the example of FIG. 3, node 301 describes a virtual camera located in the 3D volume of the XR application. Node 302 describes a virtual car and comprises an index of a representation of the car, for example an index in an array of 3D meshes. Node 303 is a child of node 302 and comprises a description of one wheel of the car. The same way, it comprises an index to the 3D mesh of the wheel. The same 3D mesh may be used for several objects in the 3D scene as the scale, location and orientation of objects are described in the scene nodes. Scene graph 310 also comprises nodes that are a description of the spatial relation between the real objects and the virtual objects.

In time-based media streaming, the scene description itself can be time-evolving to provide the relevant virtual content for each sequence of a media stream. For instance, for advertising purpose, a virtual bottle can be displayed on a table during a video sequence where people are seated around the table. This kind of behavior can be achieved by relying on the framework defined in the Scene Description for MPEG media document.

Although the MPEG-I Scene Description framework ensures that the timed media and the corresponding relevant virtual content are available at any time, there is no description of how a user can interact with the scene objects at runtime for immersive XR experiences.

In our previous work, a solution is proposed to augment the time-evolving scene description by adding “behavior” data. These behaviors are related to pre-defined virtual objects on which runtime interactivity is allowed for user specific XR experiences. These behaviors are also time-evolving and are updated through the existing scene description update mechanism.

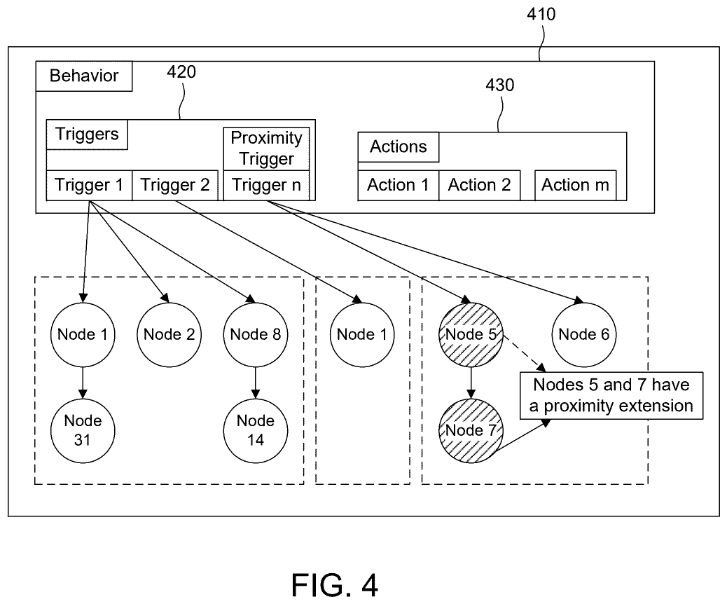

FIG. 4 shows an example of an extended reality scene description comprising behavior data, stored at scene level, describing how a user can interact with the scene objects, described at node level, at runtime for immersive XR experiences. When the XR application is started, media content items (e.g., meshes of virtual objects visible from the camera) are loaded, rendered and buffered to be displayed when triggered. For example, when a plane surface is detected in the real environment by sensors, the application displays the buffered media content item as described in related scene nodes. The timing is managed by the application according to features detected in the real environment and to the timing of the animation. A node of a scene graph may also comprise no description and only play a role of a parent for child nodes. FIG. 4 shows relationships between behaviors that are comprised in the scene description at the scene level and nodes that are components of the scene graph. Behaviors 410 are related to pre-defined virtual objects on which runtime interactivity is allowed for user specific XR experiences. Behavior 410 is also time-evolving and is updated through the scene description update mechanism.

A behavior comprises:
triggers 420 defining the conditions to be met for its activation;
a trigger control parameter defining logical operations between the defined triggers;
actions 430 to be proceeded when the triggers are activated;
an action control parameter defining the order of execution of the related actions;
a priority number enabling the selection of the behavior of highest priority in the case of competition between several behaviors on the same virtual object at the same time;
an optional interrupt action that specifies how to terminate this behavior when it is no longer defined in a newly received scene update; for instance, a behavior is no longer defined if a related object does not belong to the new scene or if the behavior is no longer relevant for this current media (e.g., audio or video) sequence.

Behavior 410 takes place at scene level. A trigger is linked to nodes and to the nodes' child nodes. In the example of FIG. 4, Trigger 1 is linked to nodes 1, 2 and 8. As Node 31 is a child of node 1, Trigger 1 is linked to node 31. Trigger 1 is also linked to node 14 as a child of node 8. Trigger 2 is linked to node 1. Indeed, a same node may be linked to several triggers. Trigger n is linked to nodes 5, 6 and 7. A behavior may comprise several triggers. For instance, a first behavior may be activated by trigger 1 AND trigger 2, AND being the trigger control parameter of the first behavior. A behavior may have several actions. For instance, the first behavior may perform Action m first and, then action 1, “first and then” being the action control parameter of the first behavior. A second behavior may be activated by trigger n and perform action 1 first and, then action 2, for example.

Different formats can be used to represent the node tree. For example, the MPEG-I Scene Description framework using the Khronos glTF extension mechanism may be used for the node tree. In this example, an interactivity extension may apply at the glTF scene level and is called MPEG_scene_interactivity. The corresponding semantic is provided in Table 1, where ‘M’ in ‘Usage’ column indicates that the field is mandatory in a XR scene description format and ‘O’ indicates the field is optional.

TABLE 1

| Name | Type | Usage | Description |
|---|---|---|---|
| triggers | Array | M | Contains the definition of all the triggers |
| | | | used in that scene. |
| actions | Array | M | Contains the definition of all the actions used |
| | | | in that scene. |
| behaviors | Array | M | Contains the definition of all the behaviors |
| | | | used in that scene. A behavior is composed |
| | | | of a pair of (triggers, actions), control |
| | | | parameters of triggers and actions, a priority |
| | | | weight and an optional interrupt action. |

In this example, items of the array of field ‘triggers’ are defined according to Table 2.

TABLE 2

| Name | Type | Usage | Description |
|---|---|---|---|
| type | enum | M | Defines the type of the trigger by taking one of the |
| | | | following values: |
| | | | VISIBILITY = 0, |
| | | | PROXIMITY = 1, |
| | | | USER_INPUT = 2, |
| | | | TIMED = 3, |
| | | | COLLIDER = 4. |
| activateOnce | Boolean | M | If FALSE: the trigger is activated each time its |
| | | | conditions are met. |
| | | | If TRUE: the trigger is activated once when its |
| | | | conditions are met. |

. . .

| | | | |
|---|---|---|---|
| If (type = PROXIMITY) | | | |
| { | | | |
| distanceLowerLimit | number | M | Threshold min in meters for node proximity |
| | | | calculation. |
| distanceUpperLimit | number | O | Threshold max in meters for node proximity |
| | | | calculation. |
| nodes | array | | Indices of the nodes in the nodes array to be |
| | | | considered. All nodes shall have a distance from |
| | | | the user camera greater than distanceLowerLimit |
| | | | and smaller than distanceUpperLimit to activate |
| | | | the trigger. |
| } | | | |

. . .

As can be seen from the example of Table 2, the proximity can be handled by a proximity trigger at the scene level, with attributes distanceLowerLimit and distanceUpperLimit.

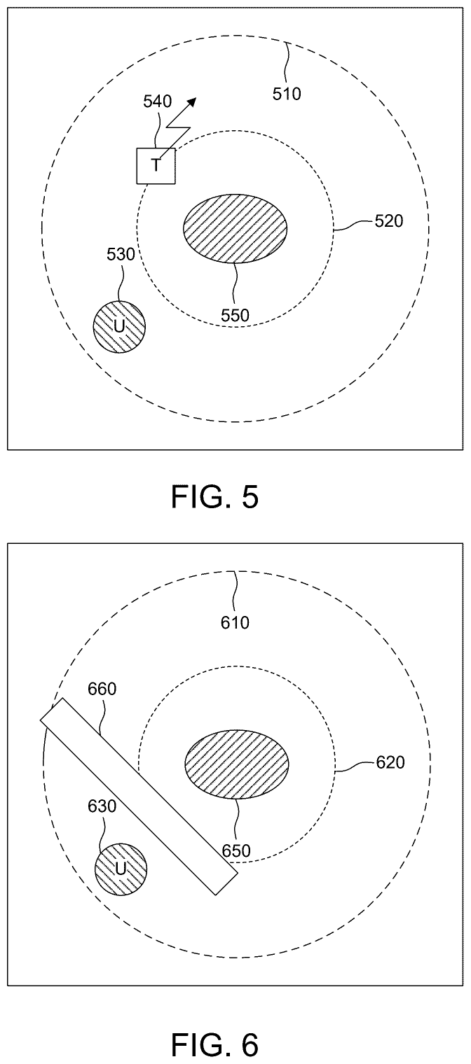

FIG. 5 illustrates a scene, where U (530) is the node associated to the user (the camera), T (540) is the trigger, and the ellipse (550) is a concerned node (in the scope of the trigger, included in set “nodes” of the trigger). A circle (510) of radius distanceUpperLimit from the concerned node (550) and a circle (520) of radius distanceLowerLimit are also shown in FIG. 5. In this example, because the distance from node 530 to node 550 is between distanceUpperLimit and distanceLowerLimit, the trigger is activated.

In another embodiment, the node “U” can be a node of the scene. The application is responsible for checking the threshold min and max on nodes to determine whether to activate the trigger at runtime.

The proximity criteria will be computed between the user (e.g., the camera) and the considered nodes. Behaviors take place at scene level. With this mechanism, a set of nodes is considered to compute the activation of the trigger. Using Table 2 as the examples, the distance between “nodes” in field “triggers” and node “User” for example are computed and are compared with distanceLowerLimit and distanceUpperLimit. If the distance is within distanceLowerLimit and distanceUpperLimit, then the trigger is activated. However, in this generic mechanism for a proximity trigger, the parameters are defined at scene level and therefore the same proximity computation is used for each node.

However, the creator of a virtual scene may require defining node-specific proximity criteria depending on the nature and/or size of the object geometry related to that node, for example, proximity criteria may be different for a big or a small object, or angle of approach can be considered.

During computation, there may be different solutions to manage occlusion (object between user and target), for example, by adding a visibility trigger, or adding a set of nodes not considered during computation in attributes list (for example, in FIG. 6, we don't consider rectangle 660).

FIG. 6 illustrates a scene, where U (630) is the node associated to the user, the ellipse (650) is a concerned node, and node 660 is between nodes 630 and 650 (there is an occlusion). A circle (610) of radius distanceUpperLimit from the concerned node (650) and a circle (620) of radius distanceLowerLimit are also shown in FIG. 6. In this example, in case of occlusion, we have to decide if the obstacle is taken into account or not when the distance is computed.

This disclosure provides a solution to specialize the proximity criteria for any node of a scene description. In one embodiment, we propose to augment a scene description by specializing the criteria of proximity at the node level for dedicated proximity triggering. For example, the scene description augmentation at the node level includes one or more of the following parameters:
Parameters specifying the capture volume, i.e., a 3D volume used for the proximity determination. The 3D volume may be specified as a proximity frustum, or more generally using a mesh to indicate the capture volume. Alternatively, the capture volume can be chosen using two weight parameters which indicates the proximity importance to the node. The weights can be set by the designer of the scene, for example, depending on the size of the object. In another example, the weights for a node close to a car is different than the one close to a dog, and they can also depend on the nature of the node.
A Boolean parameter that indicates whether occlusion is considered or not.
A Boolean parameter that indicates if geospatial coordinates are used.
The geospatial coordinates, if geospatial coordinates are used. Geospatial coordinate is an absolute position reference, and is mainly used in case of outdoor application. For example,
MPEG defines a representation for geocoordinates:

```
″MPEG_geo_coordinates″: [
  {
    ″RTC_x″: 6378137,
    ″RTC_y″: 0,
    ″RTC_z″: 0,
    ″longitude″: −1509949440,
    ″latitude″: 0,
    ″altitude″: 7137000
  }
```

This node level information encompasses the child nodes of this node if present.

In the following, the proposed augmentation is described using the MPEG-I Scene Description framework with the Khronos glTF extension mechanism to support additional scene description features. However, the present principles may be applied to other existing or upcoming descriptions of XR scene.

The “MPEG_node_proximity_trigger” extension is defined at node level. When this extension is carried by a node, specific attributes are used for the computation of the trigger. The semantic of the MPEG_node_proximity_trigger at node level is provided in TABLE 3.

TABLE 3

| Name | Type | Usage | Default | Description |
|---|---|---|---|---|
| use_geocoordinates | Boolean | O | | Indicates if geo coordinates are used |
| If(use_geocoordinate){ | | | | |
| geo_coordinates | Number | M | N/A | Index to geo coordinate item in array |
| | | | | in MPEG_GEO_COORDINATES |
| | | | | extension |
| } | | | | |
| allow_occlusion | Boolean | M | True | Indicates if occlusion by other nodes |
| | | | | should be considered |
| geometric_ROI | Enum | O | | Defines the type of 3D volume used |
| | | | | to specify the capture area. |
| | | | | MESH = 0 |
| | | | | FRUSTUM = 1 |
| | | | | WEIGHT = 2 |
| If(MESH){ | | O | | |
| mesh | number | | | Index of the mesh in the scene |
| | | | | meshes array that will be used to |
| | | | | compute proximity |
| } | | | | |
| If(FRUSTUM){ | | O | | |
| fov | number | M | | Value of horizontal fov in rad |
| aspect_ratio | number | M | | Value of aspect ratio |
| far_plane | number | O | | Distance of far plane |
| near_plane | number | O | | Distance of near plane |
| axis | Vector3 | M | | Axis |
| } | | | | |
| If(WEIGHT){ | | O | | |
| upper_distance_weight | number | M | 1 | The weight applied to the |
| | | | | distanceUpperLimit parameter |
| | | | | defined at scene level |
| lower_distance_weight | number | M | 1 | The weight applied to the |
| | | | | distanceLowerLimit parameter |
| | | | | defined at scene level |
| } | | | | |

The most efficient placement to define geospatial coordinates is at scene level, but alternative placement could be envisaged (e.g., at the node level).

### Weight Attribute

Parameters distanceLowerLimit and distanceUpperLimit are defined at scene level. Hence, the same values are applied to the set of nodes handled by the trigger (attributes “nodes”). With the weight attribute, it is possible to apply a scaling factor to the distance parameters at node level:
distanceLowerLimit (node level)=lower_distance_weight*distanceLowerLimit (scene level)
distanceUpperLimit (node level)=upper_distance_weight*distanceUpperLimit (scene level)

This is useful if the designer wishes to give a different weight to the nodes, for example, taking into account the size. The same result can be achieved by setting a trigger per node at scene level.

### Proximity Frustum

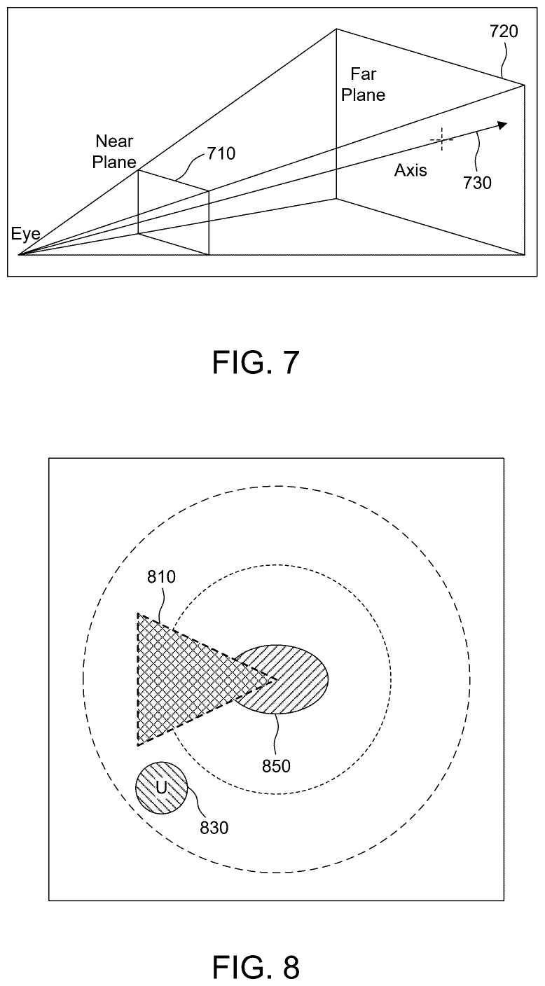

We propose to add a frustum to activate the proximity trigger, as illustrated in FIG. 7. A frustum is defined by four parameters, the near plane (710), the far plane (720), the field of view and the aspect ratio. The axis (730) allows the positioning of the frustum in space. Eye is positioning at the centroid of the object.

With this approach, it is possible to capture objects inside frustum (the portion of the pyramid between the near plane and far plane in FIG. 7). By default, the far plane (720) is set at the distanceUpperLimit defined at scene level and the near plane (710) at the distanceLowerLimit. To add flexibility, it is possible to define the near and the far plane at the node level. The “eye” of the frustum is set to the centroid of the node geometry. The proximity frustum is positioned relative to an axis (730).

For simplicity, in the following examples, the frustum is represented as a triangle, near plane is set to 0 and the far plane is set to a fixed value.

FIG. 8 illustrates a case of trigger with frustum, where node U (830) is a node associated with the user, node 850 is a concerned node. Because U (830) is outside the frustum (810), the trigger is not activated.

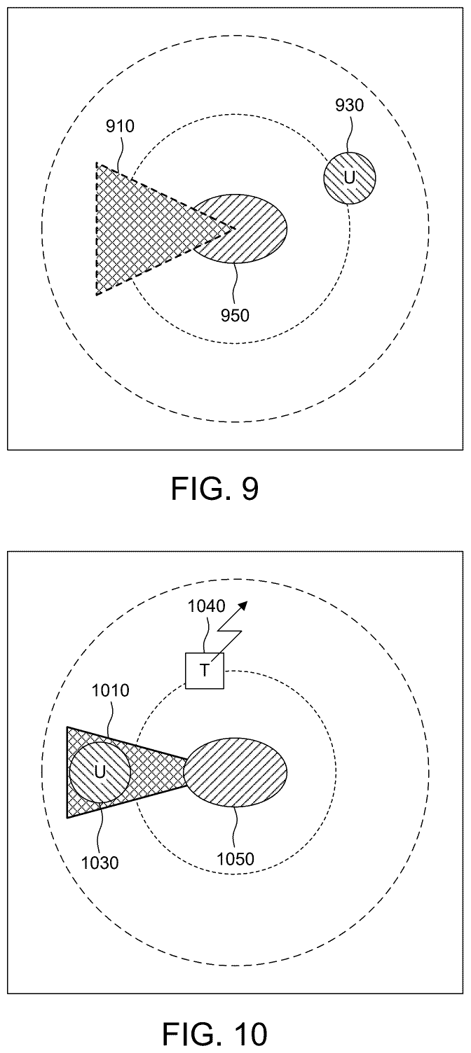

FIG. 9 illustrates another case of trigger with frustum, where node U (930) is a node associated with the user, node 950 is a concerned node. Because U (930) is outside the frustum (top view, 910), the trigger is not activated.

FIG. 10 illustrates another case of trigger with frustum, where node U (1030) is a node associated with the user, node 1050 is a concerned node. Because U (1030) is inside the frustum (top view, 1010), the trigger (1040) is activated

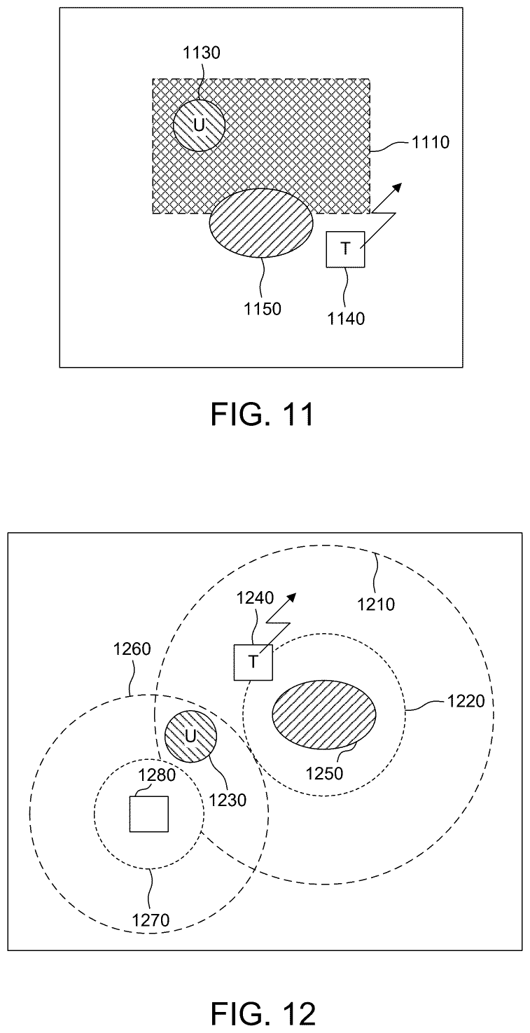

FIG. 11 illustrates another case of trigger with mesh, where node U (1130) is a node associated with the user, node 1150 is a concerned node. Because U (1130) is inside the mesh (1110), the trigger (1140) is activated.

FIG. 12 illustrates a case of trigger with weight, where node U (1230) is a node associated with the user, node 1250 is a concerned node. A circle (1210) of radius distanceUpperLimit from the concerned node (1250) and a circle (1220) of radius distanceLowerLimit are also shown in FIG. 12. FIG. 12 also illustrates another concerned node (1280) with weighted distances. In particular, a circle (1260) of radius (distanceUpperLimit*upper_distance_weight) from the concerned node (1280) and a circle (1270) of radius (distanceLowerLimit*lower_distance_weight) are also shown in FIG. 12. In this example, weights are applied to the parameters of the second concerned node (1280), and the radius of the circles (1260, 1270) are smaller than the radius of circles (1210, 1220) because the values of upper_distance_weight and lower_distance_weight are set to be less than 1. In this example, we consider that nodes 1250 and 1280 are in the set “nodes” of the trigger. Because U is between the circles (1260, 1270) and (1210, 1220), the trigger (1240) is activated.

A syntax example of such proximity extensions in the MPEG-I Scene Description is provided in TABLE 4. Fields introduced by the present methods are in bold.

```
TABLE 4
{
  ″extensionsUsed″: [
    ″MPEG_scene_interactivity″,
    ″MPEG_node_proximity_trigger″
  ],
  ″scene″: 0,
  ″scenes″: [
    {
      ″extensions″: {
        ″MPEG_scene_interactivity″: {
          ″triggers″: [
            {
              ″type″: PROXIMITY,
              ″distanceLowerLimit″: 0,
              ″distanceUpperLimit″: 5,
              ″nodes″: [ 0, 1]
            }
          ],
          ″actions″: [
            {
              ″type″: ACTIVATE,
              ″activationStatus″: ENABLED,
              ″nodes″: [0, 1]
            }
          ],
          ″behaviors″: [
            {
              ″triggers″: [0],
              ″actions″: [0]
            }
          ]
        }
      }
    }
  ],
  ″nodes″: [
    {
      ″extensions″: {
        ″MPEG_node_proximity_trigger″: {
          ″allow_occlusion″: true,
          ″geospatial_coordinates″: false,
          ″geometric_ROI″: FRUSTUM,
          ″fov″: 0.2,
          ″aspect_ratio″: 1,
          ″far_plane″: 10,
          ″near_plane″: 1,
          ″axis″: [0, 0.5, 1]  }
      },
      ″name″: ″Node0″,
      ″mesh″: 0,
      ″matrix″: [ 1,0,0,0,
            0,0,−1,0,
            0,1,0,0,
            −16.2,−5.5,44.8,1 ]
    },
    {
      ″name″: ″Node1″,
      ″mesh″: 1,
      ″matrix″: [ 1,0,0,0,
            0,0,−1,0,
            0,1,0,0,
            15,5,−18,1 ]
    },
    {
      ″name″: ″Node2″,
      ″mesh″: 2,
      ″matrix″: [ 1,0,0,0,
            0,0,−1,0,
            0,1,0,0,
            −5,7,−1,1 ]
    },
    ...
  ]
  ...
}
```

At the scene level:
A single interactivity behavior is defined and is composed of
   one proximity trigger (“type”: PROXIMITY)
      “distanceLowerLimit”: 0
      “distanceUpperLimit”: 5
      Nodes to be considered under this trigger: Node0, Node1 (“nodes”: [0, 1])
   an activate action
   behavior
      Set of triggers and actions, in this case one trigger and one action

At the node level:
First node Node0: with extension at scene and node level (trigger capability) for this case, the frustum is selected and occlusion is checked (allow_occlusion=true)
   allow_occlusion (true): we consider the occlusion (test only visible nodes)
   geospatial_coordinates (false): don't use geospatial coordinates
   “geometric_ROI” (FRUSTUM): use a frustum (defined by FOV, aspect_ratio, near plane and far plane). The orientation of the frustum is given by the axis.
Second node Node1: with only extension at scene level (trigger capability)
Third node Node2: with no extension (no trigger capability) because it is not a node to be considered by the trigger.

Another syntax example of proximity extensions in the MPEG-I Scene Description is provided in TABLE 5.

```
TABLE 5
{
  ″extensionsUsed″: [
    ″MPEG_scene_interactivity″,
    ″MPEG_node_proximity_trigger″
  ],
  ″scene″: 0,
  ″scenes″: [
    {
      ″extensions″: {
        ″MPEG_scene_interactivity″: {
                ″triggers″: [
                      {
                        ″type″: PROXIMITY,
                        ″distanceLowerLimit″: 0,
                        ″distanceUpperLimit″: 5,
                        ″nodes″: [ 0, 1]
                      }
                ],
                ″actions″: [
                      {
                        ″type″: ACTIVATE,
                        ″activationStatus″: ENABLED,
                        ″nodes″: [0, 1]
                      }
                ],
                ″behaviors″: [
                      {
                        ″triggers″: [0],
                        ″actions″: [0]
                      }
                ]
        }
      }
    }
  ],
  ″nodes″: [
    {
      ″extensions″: {
        ″MPEG_node_proximity_trigger″: {
                ″allow_occlusion″: true,
                ″geospatial_coordinates″: true,
                  ″geo_coordinates″: {
                ″RTC_x″: 6378137,
                ″RTC_y″: 0,
                ″RTC_z″: 0,
                ″longitude″: −1509949440,
                ″latitude″: 0,
                ″altitude″: 7137000
                },
                ″geometric_ROI″: WEIGHT,
                  “lower_distance_weight” = 0.2,
                    “upper_distance_weight” = 0.25
      },
      ″name″: ″Node0″,
      ″mesh″: 0,
      ″matrix″: [ 1,0,0,0,
                      0,0,−1,0,
                      0,1,0,0,
                      −16.2,−5.5,44.8,1 ]
    },
    {
      ″extensions″: {
        ″MPEG_node_proximity_trigger″: {
                ″allow_occlusion″: true,
                ″geospatial_coordinates″: true,
                  ″geo_coordinates″: {
                ″RTC_x″: 6478137,
                ″RTC_y″: 0,
                ″RTC_z″: 0,
                ″longitude″: −1209949440,
                ″latitude″: 0,
                ″altitude″: 8237000
        },
          ″geometric_ROI″: WEIGHT,
            “lower_distance_weight” = 0.8,
              “upper_distance_weight” = 0.9
      },
      ″name″: ″Node1″,
      ″mesh″: 1,
      ″matrix″: [ 1,0,0,0,
                      0,0,−1,0,
                      0,1,0,0,
                      15,5,−18,1 ]
    }, ...
  ]
  ...
}
```

At the scene level:
A single interactivity behavior is defined and is composed of
   one proximity trigger (“type”: PROXIMITY)
      “distanceLowerLimit”: 0
      “distanceUpperLimit”: 5
      Nodes to be considered under this trigger: Node0, Node1 (“nodes”: [0, 1])
   an activate action
   behavior: Set of triggers and actions, in this case one trigger and one action

At the node level:
First node Node0: with extension at node level (trigger capability)
   In this case, the weight is selected and occlusion is checked (allow_occlusion=true), geo_coordinates are selected.
      allow_occlusion (true): we consider the occlusion (test only visible nodes)
      geospatial_coordinates (true): geospatial coordinates are used (to indicate the position of the node)
      “geometric_ROI” (WEIGHT): apply a scaling factor to distance defined at scene level.
Second node Node1: with extension at node level to use geo_coordinates too.
   allow_occlusion (true): we consider the occlusion (test only visible nodes)
   geospatial_coordinates (true): geospatial coordinates are used (mandatory in this case)
   “geometric_ROI” (WEIGHT): apply a scaling factor to distance defined at scene level.

### Runtime Processing Model

During runtime, the application iterates on each defined behavior (which could be defined at scene level). If an “proximity extended” node is affected, the attributes listed in TABLE 3 are used to compute the activation of the proximity trigger.

To compute proximity, at scene level, the Euclidian distance from node to centroid of user can be used.

To check the presence in the frustum, we loop through each plane of the frustum and compute the signed distance of the centroid to this plane the position of the centroid.

A specific mesh can be provided, this mesh defines a volume used for the trigger calculation. This mesh is not necessarily centered on the related node geometry. To check the presence in a specific mesh for example a polyhedral, it is possible to check that the projection of the user's centroid satisfies all hyperplanes defining the polyhedron.

When a weight is applied, the lower and the upper distances are multiplied by this value. This is useful to take into account the size of a node.

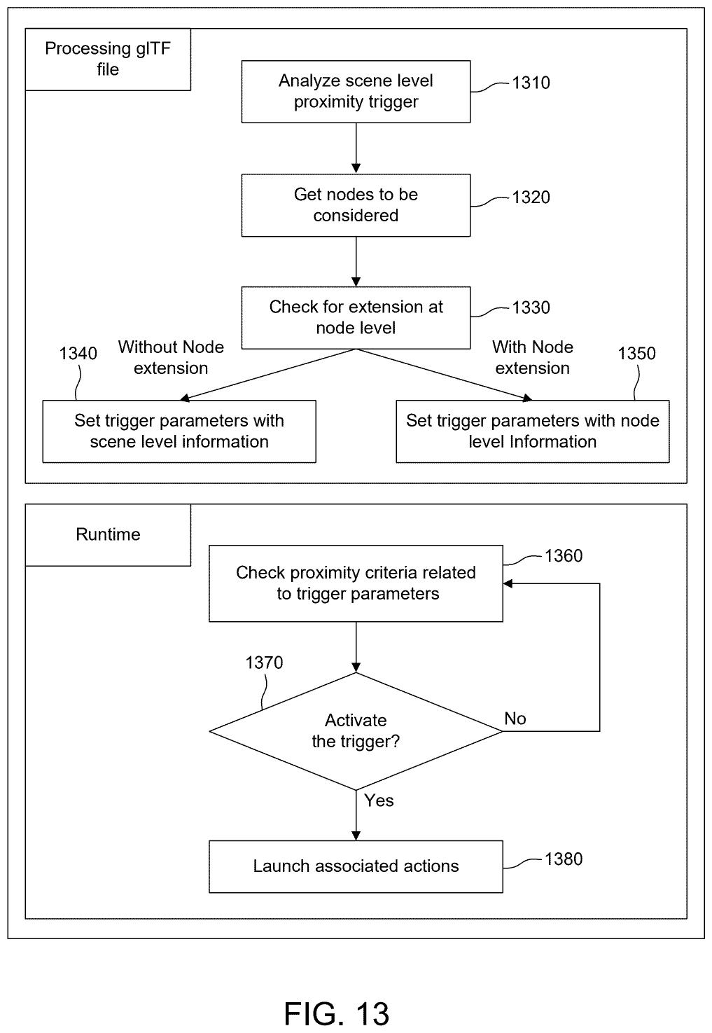

FIG. 13 illustrates a method of parsing and processing the glTF file at runtime, according to an embodiment. First, the glTF file is processed. In particular, the scene level proximity trigger is analyzed (1310), and nodes to be considered are identified (1320). Then, extension at node level are checked (1330). If present, parameters used for the triggers will be those defined at node level (1350). Otherwise, the scene level information is used (1340) as parameters for the triggers.

At runtime, for each concerned nodes, proximity criteria related to trigger parameters are checked (1360). Depending on the parameters, the trigger may be activated. In particular, if the proximity criteria are satisfied, then the trigger is activated (1370) and the associated actions are launched (1380). The monitoring of proximity criteria continues during the runtime, as the nodes and the user may move around.

FIG. 13 illustrates how the proximity parameters are processed on the receiver side. At the transmitter side, the proximity parameters are generated, based on the generation of the glTF file. The scene creator previously defines the behaviors, the glTF file can be manually or automatically generated. Then the parameters are transmitted. The parameters may be encoded (e.g., using JSON format) before being transmitted.

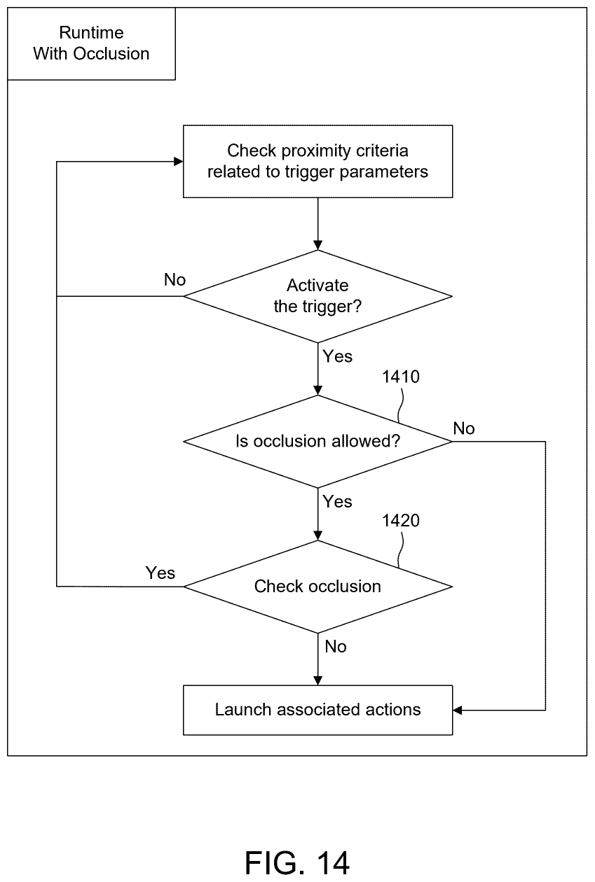

FIG. 14 illustrates a method of processing the glTF file at runtime that considers both proximity and occlusion, according to an embodiment. If the parameter allow_occlusion is present (1410) then occlusion is taken into account (1420) when launching the associated action.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device.

Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising:
obtaining at least a parameter, at node level, used to indicate that an object corresponding to a node is in proximity of another object corresponding to another node, from a description for an extended reality scene; and
activating a trigger to an action responsive to that said object is in proximity of said another object.

2-3. (canceled)

4. The method of claim 1, said description for said extended reality scene including:
an upper limit on a distance between said node and said another node at scene level; and
a first scaling factor corresponding to said upper limit at node level.

5. The method of claim 1, said description including:
a lower limit on a distance between said node and said another node at scene level; and
a second scaling factor corresponding to said lower limit at node level.

6. The method of claim 1, said description including:
one or more parameters specifying a volume, wherein said node is considered to be in proximity of said another node responsive to that said node is inside said volume.

7. The method of claim 6, wherein said volume is specified based on a mesh or frustum.

8. The method of claim 1, wherein said description further includes a parameter indicating whether occlusion is considered or not.

9. The method of claim 8, wherein said trigger is only activated if said node is not occluded by said another node.

10. The method of claim 1, wherein said description for said extended reality scene further includes a parameter indicating that geospatial coordinates are used.

11-12. (canceled)

13. A method, comprising:
generating at least a parameter, at node level, to indicate that an object corresponding to a node is in proximity of another object corresponding to another node in a description for an extended reality scene, wherein said proximity is used to activate a trigger to an action; and
transmitting said description for said extended reality scene.

14. The method of claim 13, said description for said extended reality scene including:
an upper limit on a distance between said node and said another node at scene level; and
a first scaling factor corresponding to said upper limit at node level.

15. The method of claim 13, said description including:
a lower limit on a distance between said node and said another node at scene level; and
a second scaling factor corresponding to said lower limit at node level.

16. The method of claim 13, said description including:
one or more parameters specifying a volume, wherein said node is considered to be in proximity of said another node responsive to that said node is inside said volume.

17. An apparatus, comprising one or more processors and at least one memory coupled to said one or more processors, wherein said one or more processors are configured to:
obtain at least a parameter, at node level, used to indicate that an object corresponding to a node is in proximity of another object corresponding to another node, from a description for an extended reality scene; and
activate a trigger to an action responsive to that said object is in proximity of said another object.

18. The apparatus of claim 17, said description for said extended reality scene including:
an upper limit on a distance between said node and said another node at scene level; and
a first scaling factor corresponding to said upper limit at node level.

19. The apparatus of claim 17, said description including:
a lower limit on a distance between said node and said another node at scene level; and
a second scaling factor corresponding to said lower limit at node level.

20. The apparatus of claim 17, said description including:
one or more parameters specifying a volume, wherein said node is considered to be in proximity of said another node responsive to that said node is inside said volume.

21. An apparatus, comprising one or more processors and at least one memory coupled to said one or more processors, wherein said one or more processors are configured to:
generate at least a parameter, at node level, to indicate that an object corresponding to a node is in proximity of another object corresponding to another node in a description for an extended reality scene, wherein said proximity is used to activate a trigger to an action; and
transmit said description for said extended reality scene.

22. The apparatus of claim 21, said description for said extended reality scene including:
an upper limit on a distance between said node and said another node at scene level; and
a first scaling factor corresponding to said upper limit at node level.

23. The apparatus of claim 21, said description including:
a lower limit on a distance between said node and said another node at scene level; and
a second scaling factor corresponding to said lower limit at node level.

24. The apparatus of claim 21, said description including:
one or more parameters specifying a volume, wherein said node is considered to be in proximity of said another node responsive to that said node is inside said volume.
